(19) United States
(12) Patent Application Publication
(10) Pub. No.: US 2022/0261895 A1
(43) Pub. Date: Aug. 18, 2022

(54) PEER-TO-PEER FOREIGN CURRENCY EXCHANGE BY USER UBERING

(71) Applicant: PANDA Communications Corp., Toronto (CA)

(72) Inventors: Xiaoguang Xu, Toronto (CA); Wei Wang, Shanghai (CN)

(21) Appl. No.: 17/624,674

(22) PCT Filed: Jul. 21, 2020
(86) PCT No.: PCT/CA2020/000090

§ 371 Date: Jan. 4, 2022

Related U.S. Application Data
(60) Provisional application No. 62/878,498, filed on Jul. 25, 2019.

(51) Int. Cl. G06Q 40/04; G06Q 40/06

(52) U.S. Cl. CPC G06Q 40/04; G06Q 40/06

(57) ABSTRACT

The present disclosure describes methods and systems for facilitating foreign currency exchange based on an online peer-to-peer transaction model with an automatic order matching algorithm with user confirmation. By ubering a pool of special users who are called “bankers”, the new forex system can make currency exchanges much easier and faster with better exchange rates, eliminating the need for cross-border remittances, removing regulation restrictions, and saving costs and long waiting time. This system also allows for ubering users to make commissions by serving the platform through trades, which incentivizes those users to be active and keep the platform running efficiently even if enough regular users aren't trading.

### CROSS-REFERENCE TO RELATED APPLICATIONS

This application is a national stage application, filed under 35 U.S.C. § 371, of International Patent Application No. PCT/CA2020/000090, Publication No. WO2021012033, priority date inherited is Jul. 25, 2019, filed on Jul. 21, 2020, which is incorporated by reference herein in its entirety.

### FIELD

The present disclosure is in the field of economics, finance, banking, currency exchange, and peer to peer communication. More particularly, the present disclosure relates to a new method and platform for peer-to-peer foreign currency exchange services by taking advantage of a pool of special users who share their services as ubering.

### BACKGROUND

Foreign currency exchange, commonly known as foreign exchange, forex, or FX, is the trading or conversion of one currency to another. For example, the exchange of the U.S. dollar (USD) for the Canadian dollar (CAD) or vice versa. The exchange rate is the value of one currency in comparison to another. For example, as of Jun. 26, 2019, the USD/CAD exchange rate is 1.31, which means that 1 USD is worth 1.31 CAD. Types of exchange rates include free-floating, which fluctuates as a result of changes in supply and demand in the market; restricted currency, where exchange is only allowed within the respective countries and the value can be set by the government; currency peg, where a country's currency is pegged to that of another; and onshore vs offshore, where a currency may have a more favorable rate within the respective country than outside it. Exchange rates can also have a spot rate, also known as cash value, which is the current market value, or a forward value, which depends on expectations for the currency to rise or fall from its spot price.

If a currency exchange happens between a user and a common organization, for example, a bank, it is centralized forex. This means that each transaction is recorded by price dealt and volume traded by that organization. There is usually one central place back to which all trades can be traced and there is often a centralized network of market makers. Foreign exchange transactions generally take place on the foreign exchange market, also known as the forex market. The forex market is an electronic network consisting of banks, commercial companies, central banks, investment management firms, hedge funds, and retail forex brokers and investors. The foreign exchange market (forex) averages trillions of dollars per day in trading, making it the largest market in the world. However, unlike most other exchanges such as the New York Stock Exchange or the Chicago Board of Trade, the forex market is a decentralized or over-the-counter market. There isn't one “exchange” where every trade is recorded. Trading takes place all over the world on multiple exchanges without the single characterization of an exchange listing. Instead, each market maker records his or her own transactions and keeps it as proprietary information. The forex offers high leverage for users in their currency trades.

If the transaction happens purely between two end-users, it is called peer-to-peer, a.k.a. P2P. Peer-to-peer refers to a decentralized communication model where each party possesses the equal capability and provides access to resources and data. This is in contrast to the client/server centralized model, in which the client makes a request that the server must fulfill. In P2P, each party functions as both a client and a server. While P2P systems are most commonly used for file and media sharing, they can also be used for distributed systems, sharing bandwidth, storage, accommodation, transportation, and other resources, in this case, foreign currency exchange.

For example, Uber is a transportation network company that offers peer-to-peer ridesharing. Drivers that meet Uber's requirements can apply to become a partner. Through a mobile app, riders enter their destination and view ride options available with different wait times, car sizes, and prices. They confirm their pickup location and make a trip request. A nearby driver will be matched to the request and can choose to accept it. Having accepted the request, the driver picks up the rider and takes them to the destination. At the end of the trip, both drivers and riders can give each other a rating from 1 to 5 stars. Riders can also give the drivers compliments and/or tipping where available.

Uber's success has given “uber” a new meaning. Originally a prefix indicating an outstanding or supreme example of a particular kind of person or thing, “uber” has been adopted into vernacular as a verb that can refer to the usage of Uber's services or a peer-to-peer service that functions in similar fashion to that of Uber. “ubering” now refers to a service a user provides that is similar to ridesharing with Uber.

Uber has also expanded to offer food delivery (UberEats) and bicycle-sharing (Jump) as well that operate similarly to its core service. Both restaurants and bike companies are now “ubering”. Airbnb is an online marketplace and hospitality service brokerage company that is “ubering” lodging rather than transportation.

At present, besides forex, the online exchange involves directly transferring funds from a user's bank account to the corresponding financial institution. After the financial institution exchanges the foreign currency, there are two options to complete the exchange: transfer the funds directly to the user's bank account, or, if the user needs to send money across borders, and funds transferred to another country will be remitted through the international settlement SWIFT system.

P2P services aim to cut out the middleman, like banks and brokers, by providing a fast online meeting place for those who are looking for services other users provide on the same platform. P2P forex services can help end-users to bypass banks and brokers so to lower transaction fees and improve the transaction speed.

Existing peer-to-peer forex services include WeSwap and CurrencyFair. WeSwap is a peer-to-peer currency exchange platform, focused on providing ‘travel money’ (different currencies in relatively small quantities, to be used while traveling) to their customers. WeSwap works by leveraging prepaid credit card technology to provide their customers with an easily usable card that converts to the local currency. The company now operates globally, with their credit cards licensed by MasterCard. CurrencyFair is another peer-to-peer currency exchange, which focuses on providing currency ‘exchanges’ between countries without money ever crossing borders. This means the money originally ‘transferred’ stays in the country of origin, while the user will receive new currency originating in the country they currently reside in, thereby avoiding bank fees that converting the currency would normally incur.

There are four main problems with the aforementioned existing services. The first is the lack of registered users. This means that there is only a small currency variety available, low liquidation, and less trading opportunities. The second problem is the lack of active users online at any moment. This hinders real-time trading capabilities, resulting in slow or nonexistent order fulfillment. The third problem lies in these services' approaches to solve said first and second problems. Given that these services themselves act as a bigger broker in the transactions, oftentimes they do not have enough currency to fulfill large orders or a large number of orders. The fourth problem is that there is a lack of reference points for the exchange rates. Due to the nature of P2P transactions, this means that the spread of prices in the pending orders from user to user may be very large and inconsistent, which then render unfair transactions.

The present disclosure describes methods and systems for a new peer-to-peer foreign currency exchange service that is structurally different from all existing P2P forex and aims to solve all four problems listed above. The present disclosure discusses an exchange process that allows an individual to share the currency held for exchange and after the currency exchange can withdraw to a bank account of another currency, which can be the account of the foreign exchange country or the account of another country. The present disclosure makes exchanges easier and eliminates the need for cross-border remittances, reducing long waiting times.

### SUMMARY

The present disclosure describes methods and systems for facilitating foreign currency exchange based on an online peer-to-peer transaction model with an automatic order matching algorithm with user confirmation, which is a platform for foreign currency exchange on a peer-to-peer basis, comprising: a first user with a first currency; a second user with a second currency; a processor that determines an exchange ratio for the two users; wherein the first user aims to get the second currency and the second user aims to increase his or her total value with each transaction; wherein the exchange ratio requires a confirmation from the first user. By ubering a pool of special users who are called “bankers”, the new forex system can make currency exchanges much easier and faster with better exchange rates, and eliminates the need for cross-border remittances, removing the regulation restriction, and saving costs and long waiting time. This system also allows for ubering users to make commissions on trades by serving the platform, which incentivizes those users to be active and keep the platform running efficiently even if enough regular users aren't trading.

### BRIEF DESCRIPTION OF THE DRAWINGS

FIG. 1 illustrates a basic embodiment of the peer-to-peer foreign currency exchange method of the present disclosure.

FIG. 2 illustrates an embodiment of the present disclosure when a normal user has a peer-to-peer currency exchange with a banker user completely within the platform.

FIG. 3 illustrates an alternative embodiment of the present disclosure when a normal user has a peer-to-peer currency exchange with another normal user partially within the platform.

FIG. 4 illustrates an embodiment of the realization of the peer-to-peer foreign currency exchange service of the present disclosure through existing financial accounts.

FIG. 5 illustrates an exemplary embodiment of a transaction between two normal users when each user has two financial accounts.

FIG. 6 illustrates a flow diagram of a normal user becoming a banker user in the present disclosure.

FIG. 7 illustrates an exemplary embodiment of a transaction between a normal user and a banker user when the normal user has two financial accounts.

FIG. 8 illustrates how a banker account changes its order after a transaction inside bankers' pool.

FIG. 9 illustrates an exemplary workflow of a banker account placing and changing its order before and after a transaction inside bankers' pool.

FIG. 10 illustrates a complete embodiment of the peer-to-peer foreign currency exchange method of the present disclosure.

FIG. 11 illustrates a preferred flow diagram of a peer-to-peer foreign currency exchange service trading method of the present disclosure.

FIG. 12 illustrates an exemplary embodiment of a peer-to-peer foreign currency exchange order matching algorithm for a simple scenario.

FIG. 13 illustrates an exemplary embodiment of a peer-to-peer foreign currency exchange order matching algorithm for a complicated scenario.

FIG. 14 illustrates a preferred exemplary system of the peer-to-peer foreign currency exchange service trading system of the present disclosure.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. In describing the invention, it will be understood that a number of techniques and steps are disclosed. Each of these has an individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one ordinarily skilled in the art that the present invention may be practiced without these specific details. The present disclosure is to be considered as an exemplification of the invention and is not intended to limit the invention to the specific embodiments illustrated by the figures or description below. The present invention will now be described by referencing the appended figures representing preferred or alternative embodiments.

The present disclosure describes a new online peer-to-peer foreign currency trading method that makes use of a pool of special users who provide “ubering” currency trading services to maintain the currency demand and supply level within the system. Those special users are hereinafter called “bankers”, “banker users”, or “ubering users”, interchangeably. The pool of the special users is hereinafter called “bankers' pool” or “bankers' pool”, interchangeably.

The method and system of the present disclosure offer a software platform that gathers and connects all the users who request better foreign currency exchange services and allows them to find each other and negotiate their own prices. The currency exchange happens strictly between the two end-users and there is no bank and/or organization in the middle. The platform only provides the necessary services to assist the end-users in finding each other, a place to negotiate price, and finishes the currency movement. The platform itself does not itself own any money to trade with end-users. All the currencies inside the platform belong to one of the users and the users have full control of where does the money goes and how the currencies are traded.

The key novelty of the method and system is the pool of banker users which can respond to and complete requested transactions as users request them, for a reward of course—to incentivize bankers to stay on this platform. Banker users are users who participate in the service only to earn exchange processing fees. These users do not need currency exchange services and use the service solely to gain the benefits of exchange processing. They also serve to fill the gap in the service where a regular user places an order, but no other regular user can fulfill the order—this is where banker users come in, allowing regular users to still complete transactions and then ‘flipping’ the currency for a profit afterward. Any user can apply to enter this user pool. The platform will have a reward mechanism for the banker, so that a large number of bankers will stay for a long time as participants in the transaction, and they are willing to continually exchange orders to wait for user transactions.

The ubering users are a special group of banker users who are converted to banker users from previous normal users in the platform for commissions on transactions. These users may start as normal registered users when joining the system, and can then apply to become banker users through the following process: The users are asked if they want to become banker users, and if they answer yes, are taken to the next step to select one or a group of target currencies for trading. If their accounts have enough balance right away, then the users' accounts are immediately transitioned to a banker account and an amount of the selected source currency will be transferred from the bank and deposited into the users' platform accounts. Otherwise, the user is prompted to top up their platform accounts and the process is temporarily held-up until the users top up their accounts with enough balances. They then proceed with the transition and become banker users or ubering users.

The trading platform establishes a bankers' pool mechanism as the following: a user is willing to transfer an amount M (such as 5,000 Canadian dollars) specified by the platform into a banker's account and use it to publish the transaction demand order. The process that transactions go through is as follows: A regular user will create a transaction request, in a currency X, requesting currency Y in exchange. If the platform cannot find another regular user who happens to have another request of currency Y in currency X, the transaction request will then go to the bankers' pool. A banker who owns currency Y can then take on this request, and exchange the regular user's currency X for the equivalent amount with a defined exchange rate in currency Y, incurring a reward for their work in the process.

The banker users can set up their orders in the banker pool in two ways—either as manual or automatic pending orders. If manual, the user will have to manually set up a next transaction including the currency type, quantity, desired exchange rate, expiration date, etc.

If automatic, based on the user's preference settings, the platform will automatically calculate the exchange rate and put up currency type and quantity. Bankers can set up their applications to automatically complete transactions within certain limits, such as the amount and which currencies to flip between. The user can also choose a value within a range of the actual current exchange rate—for example, the user could specify a higher rate to allow a banker to make more profit, which creates an incentive for the transaction to be completed quickly. Assuming that their balance on the platform is only Currency A, then their pending orders are exchanged from Currency A to Currency B and they will continue to exchange orders from Currency B to Currency A. The banker pool mechanism ensures that the user will have a banker's pending order with the platform transaction, thus ensuring quick transactions. The Currency B may not be fixed to one currency, it can be chosen flexibly from a group of currencies according to the market need.

For example, a banker user initially owns only $1000 US dollars. After he or she puts up a first order to exchange the $1,000 USD to $1,450 CAD, the system automatically flips upon order fulfillment and puts up a new order for the banker user to request $1,100 USD for exchanging with the current $1,450 CAD. If the new order is fulfilled, the banker user makes a net profit of $100 USD after a round trip (flipping) transactions simply by ubering the service in the bankers' pool. In this way, bankers can maintain long-term orders without manual intervention, while also retaining the ability to pick and choose what they want to respond to. Transaction requests are also sorted into their own separate lists to make them easier to sort through for bankers—for example, currency X to Y is one list, Y to X is another, X to Z is another, and so on, allowing the system to sort through and find potential transactions easily. This way allows the system to function more efficiently than current transaction systems which require work done by the central organization to function.

The main benefits of this new trading system are: increased exchange speed, increased convenience, and lower cost compared to existing solutions. The increased exchange speed comes from the ability for a fairly sized pool of banker users to directly respond to users' requests, avoiding waiting for a real-time matching between normal users' orders, which can be difficult to find if the platform user base is not big enough or the majority of users are not actively trading at a certain period of time. This can work much faster compared to a central organization under a heavy load of exchange requests. The improved convenience comes from avoiding central banks to convert currency, especially when the currencies need to cross country borders, which avoids limitations from the foreign currency policies and regulations and simplifies the whole service process. The new trading system also helps to further reduce fees that users would normally have to pay due to crossing the country borders, inter-bank transaction fees, wiring fees, processing fees, and ad-hoc currency buy-to-sell price differences from the lack of reference price points in a peer-to-peer environment. All thanks to our unique peer-to-peer exchange structure, mechanism, and algorithms.

At present, the trading method of the financial system generally puts up a buy or sell order at a certain price. The quantity and amount of the subject matter of the transaction will be displayed when the order is placed. The user who needs to make a transaction checks the price of the first few transactions and the number of pending orders of the current pending order, and then places an order. After the order is placed, the order will be traded according to the best price. If there is no pending order that is better than the order price, the order will not be fulfilled, and it will become a pending order. If the number of pending orders that are better than the order price is less than the quantity of the order, then the order can only be partially fulfilled, and the remaining part becomes a pending order to be closed. The problem with this trading method is that if there are fewer participating users, there may be insufficient volume, and the user needs to wait longer, which may cause some users to become impatient and leave. In addition, there is no price guidance, and the price of different users' pending orders may be quite different, so it is not easy to form a transaction. The method adopted a bankers' pool method and an automatic matching transaction method, thereby improving the speed and convenience of user exchange.

The order published by the user pool user (banker) is synchronized to the in-memory database to create a list of currency pairs, which is sorted. In the in-memory database, sort the transaction currency pairs according to the exchange and create a sorted order list for each category. For example, all orders for the US dollar for Canadian dollars enter the same list L1, while orders for Canadian dollars for the US dollar enter another list L2.

The ordering rules in the new platform for the orders in the order list are used to sort the normal users' order listings and the bankers' order listings. First, orders from the best exchange rate are ranked first, from the perspective of the order taker. That is, for the order placing user, the lowest exchange rate ranking is the first priority. Secondly, if the exchange rates of two orders are the same, the earlier the pending orders are, the higher the priority. For example, the order for the US dollar against the Canadian dollar has three orders A, B, and C. The exchange rates are 1.3, 1.4, and 1.4, respectively, and the pending orders are 9:40, 9:30, and 9:29. The demand for users who receive orders is to exchange US dollars for Canadian dollars. For single users, 1.3 is a better exchange rate than 1.4. The exchange rate of order A is 1.3, so A should be ranked first, leaving the exchange rate of orders B and C orders. According to the order of pending orders, C's pending orders time is earlier than B's, so C should be ranked in front of B, and the final order is A, C, B.

The user pool user (banker) pending orders can choose two types of pending orders: manual pending orders and automatic pending orders. The manual pending order involves filling in the exchange rate within the range of 5% of the middle price given by the platform, filling in the exchange amount, selecting the originating currency and target currency of the transaction, and then placing the order. With the automatic pending order, the banker user can set the platform to help the banker automatically place the order. Banker users can set a currency trading pair, such as the US dollar and Canadian dollar, and the minimum amount of the pending order, then when the corresponding two currency balances exceed the set minimum amount, the platform will automatically place the remaining amount of the currency pending to redeem another currency. This way banker users can maintain long-term pending orders without manual operation. A typical exchange user can easily search for a banker's pending order for a quick transaction.

It will be evident, however, to one who is ordinarily skilled in the art that the present disclosure may not follow exactly with these specific example details. The above examples are to be considered as an exemplification of the method and system, and are not intended to limit the invention to the specific embodiments illustrated by the numbers or descriptions.

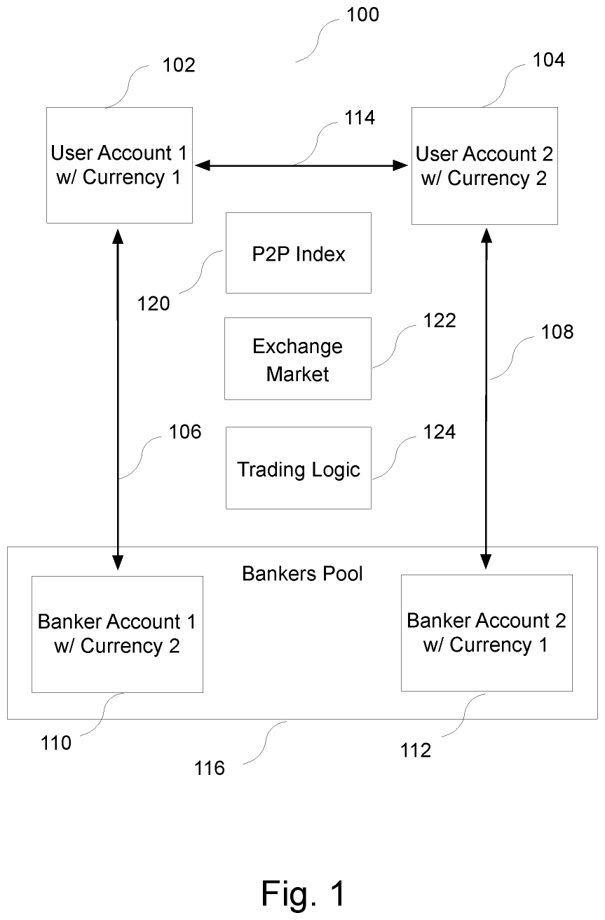

FIG. 1 illustrates a basic embodiment of the peer-to-peer foreign currency exchange method of the present disclosure. In this forex (foreign exchange) platform (100) there are regular users (102, 104) as well as special users called bankers (110, 112). Bankers are also called ubering users who uber their forex services for the platform. Both of these types of users hold a certain amount of currency balance inside the forex platform. This money has been transferred into the forex platform. The bankers are a part of a larger bankers' pool (116) that is a unique feature of this currency exchange platform. These bankers serve to facilitate exchanges when there are not enough real users to fulfill all the orders.

User 1 (102) with Currency 1 can use this P2P forex platform to directly initiate a P2P exchange (114) with User 2 (104) who has Currency 2, provided the User 2 exists at the moment. Alternatively, User 1 (102) can initiate an exchange (106) with Banker 1 (110) in the bankers' pool (116) who has Currency 2 and is almost always available. In the same way, User 2 can also initiate exchanges (114, 108) with User 1 or Banker 2 (112), both of whom have their desired currencies and are available at most of the time.

For example, if User 1 (102), who has an account in Currency 1 was to want to exchange their currency for Currency 2, they can complete an exchange (114) with a User 2 (104) who has an account with Currency 2 and wants to exchange it for Currency 1. If there is no user to complete the exchange, that is, if User 2 (104) did not exist, User 1 (102) can exchange with someone from the bankers' pool (116). In this way, User 1 (102) is still able to fulfill their order and exchange their money, even if there is no other regular user to complete the exchange with. A regular user will always trade with another user or a banker. A banker will never complete an exchange with another banker. These exchanges also require the P2P indexing service (120), which contains a list of users, their addresses, and their status, the exchange market (122), which contains all of the current exchanges posted, and the trading logic (124), which is the software program that contains the data structures, rules and policies that allows the trades to occur. The P2P index (120), the exchange market (122), and the trading logic (124) are all part of the forex platform which uses the method of the present disclosure.

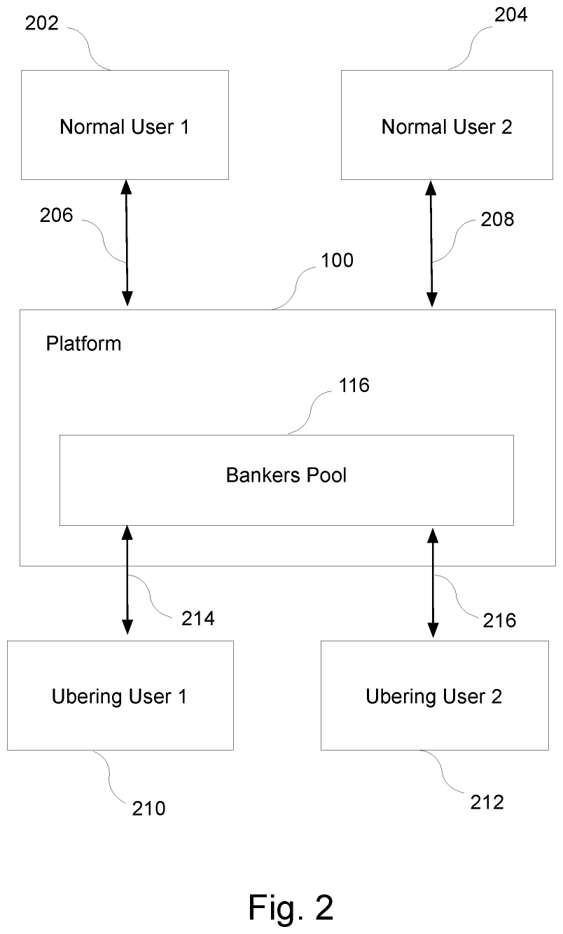

FIG. 2 illustrates a preferred embodiment of normal users (202, 204) and ubering or banker users (210, 212) connecting to the platform. All currencies requested by users are supported by the platform and its financial accounts. There is no need for any users to have transactions offline or outside of the platform. That is, all transactions are going through the platform.

Normal User 1 (202) is connected with the P2P forex platform of the present disclosure via a means of communication and their financial services (206), and Normal User 2 (204) is connected with the same forex platform (100) via another mean of communication and other financial services (208). The bankers' pool (116), which is a part of the forex platform (100) then connects with the ubering users (210, 212) via some financial channels (214,216) respectively. All communication means and financial services enable the user to operate and fund their platform accounts with currencies required or withdraw the remaining currencies from their platform accounts. Examples of such financial means are, but are not limited to, bank ACH wiring and electronic funds transfer, PayPal transfer, email money transfer, cheque, credit card payment, and cash-over-the-counter payment, etc. Examples of the such communication means are, but are not limited to, the internet and telephone calls.

For example, Normal User 1 (202) has Currency A and would like to exchange it for currency B. Normal User 1 first deposit enough Currency A into his or her platform account through the financial channel (206), then posts a request through the forex platform to exchange Currency 1 for Currency 2. However, no normal users currently offer this trade. Either ubering User 1 (210) or ubering User 2 (212) can respond to this request through their connections to the platform (214, 216) and trade for the aforementioned user's Currency A with Currency B at some agreed exchange rate. Alternatively, ubering User 1 (210) or ubering User 2 (212) may respond to the request with their automatic active orders in the bankers' pool (116). Normal User 2 (204) can also complete this process in the same way as Normal User 1 (202) can, using his or her financial channels and communication connection to the platform (208). In this way, the forex platform facilitates trades by connecting Normal Users (202,204) with ubering Users (210,212) in the bankers' pool (116).

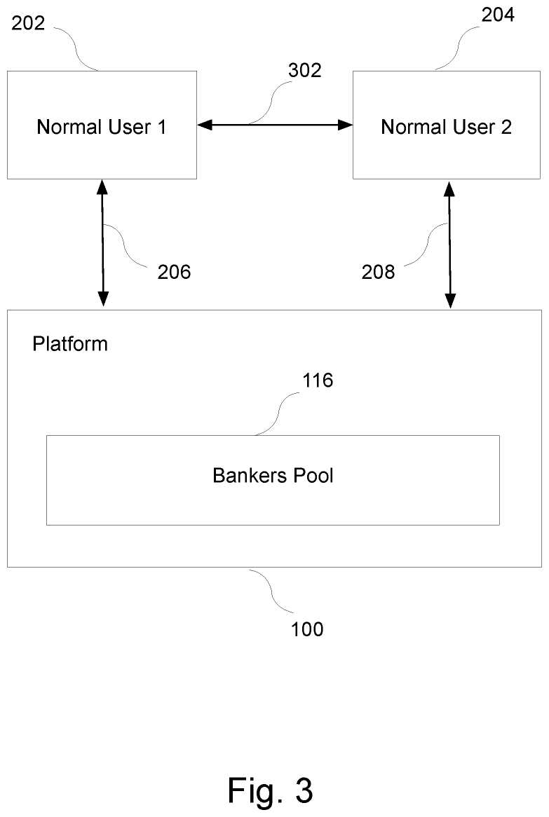

FIG. 3 illustrates an alternative embodiment of two normal users conducting currency exchange partially within the platform. It also shows that the two users can simultaneously communicate both with the platform and with each other (independently of the platform). One of the situations is, but not limited to, when at least one of the required currencies is not supported by the platform's financial account. The transaction of that currency must happen outside of the platform but still be monitored and controlled by the platform.

The first Normal User (202) and the second Normal User (204) are both connected to the platform (100) through some financial services, methods, or devices (206, 208), and as a result, also connected to the banker's pool (116). However, these users are also connected to each other (via a financial service, method, or device, 302) and are capable of processing trades between themselves with assistance from the platform. For example, Users 1 and 2 could exchange currencies between themselves with the platform's help but without requiring currencies to go through the platform or banker users. As an example: Normal User 1 (202) wants to exchange Currency A for Currency B; he or she can either use the forex platform (100) and any present ubering users to perform the exchange (as presented in FIG. 2), or he or she can make use of the P2P index and exchange currency with other normal users (in this case, Normal User 204). Typically, if another normal user (204) is offering an appropriate trade, the trade would happen between the normal users first, before looking for trades in the bankers' pool. The two normal users can choose to complete the trade (302) without requiring currencies to go through the main forex platform (100) and the bankers' pool (100). This trade (302) only requires two normal users, with the appropriate currency type and amount, and does not require any interaction with the bankers' pool (116) or any ubering users.

Another example is if Normal User 1 (202) wanted to exchange Currency C for Currency D. If the forex platform does not support either or both of Currency C and/or D, meaning that no banker users in the banker pool (116) are trading those currencies or none of the financial accounts of the platform support (depositing and withdrawing) those currencies, Normal User 1 can only directly trade directly with another normal user who has the appropriate currencies. If Normal User 2 (204) wants to trade Currency D for Currency C, then a trade (302) could be made between the two users without having to interact with the bankers' pool (116).

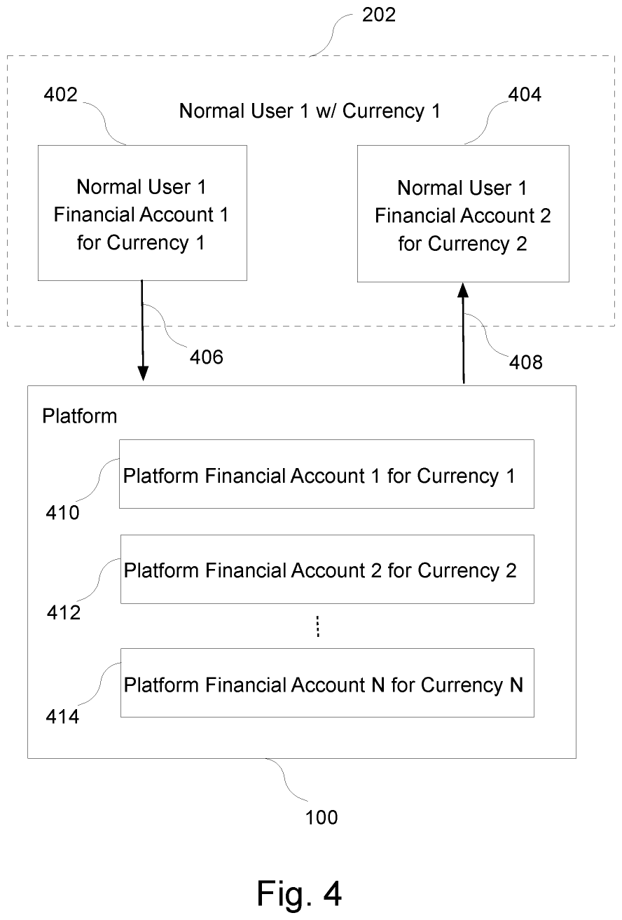

FIG. 4 displays an embodiment of the realization of the peer-to-peer foreign currency exchange service of the present disclosure through existing financial accounts. Here, the financial account includes, but is not limited to, an existing bank account, a PayPal account, an e-transfer or a manual cash deposit. Normal User 1 (202) is allowed to have two financial accounts (402, 404), one (402) with Currency 1 and the other (404) with Currency 2, associated with his or her platform account. Similarly, the platform also has several (N) financial accounts (410, 412, 414), wherein N is the total number of the financial accounts the platform operates; the financial account (410) has Currency 1, the financial account (412) has Currency 2, and the financial account (414) has Currency N.

Financial Account 1 (402) enables User 1 to deposit Currency 1 into his or her platform account via a connection (406). This currency will be put into the first platform account (410) that works with Currency 1 on the platform (100). Once the currency has been put into the platform financial accounts, it can then be withdrawn back to a different external account in a new currency. Here, for example, Normal User 1 (202) withdraws Currency 2 (408) into his or her Financial Account 2 (404).

In yet another embodiment of the present disclosure, User 1's two financial accounts may reside in two different countries. Financial Account 1 for Currency 1 is in the first country and Financial Account 2 for Currency 2 is in the second country. Because User 1 can deposit the Currency 1 in the first country and withdraw the Currency 2 in the second country, User 1 successfully avoids carrying Currency 1 to the second country and exchanging the money for Currency 2 locally. Not only does the service save the effort for User 1, he or she also gets the best exchange rate and saves the currency conversion fees.

In this way, a normal user can transfer his or her own currency to and from the platform and different external financial accounts. The actual exchange still happens between either two normal users or one normal user and one banker user. In an exemplary embodiment, Normal User 1 (202) has an account with Bank A, which has 100 of Currency 1. In this example, we will call this Financial Account 1 with Currency (402). Normal User 1 (202) also has a second account with Bank B, which has amount 300 of currency 2 and will be referred to as Financial Account 2 with Currency 2 (404). This user then connects to the platform and interacts with a platform financial account (410) for Currency 1, and a platform financial account (412) for Currency 2. The user can interact with up to N accounts on the platform that can accept money from as many other financial accounts as they want (412, 414). In this case, the user only creates two platform financial accounts, one platform account for Currency 2 (412) and one for Currency 1 (410).

The user can then deposit 100 of Currency 1 from their financial account (402) into platform Financially Account 1 (410). They can then use this Currency 1 in trades for Currency 2 with another active normal user or banker, which would go into platform Financial Account 2 (412). The user (202) can then withdraw (408) the money in the platform Financial Account 2 (412) into Financial Account 2 (404). This works the opposite way as well. The user (202) can deposit Currency 2, do a trade with another peer user or banker in the pool, and then withdraw Currency 1. It is also possible to deposit Currency 1 and then withdraw Currency 1 as well and deposit Currency 2 and then withdraw Currency 2.

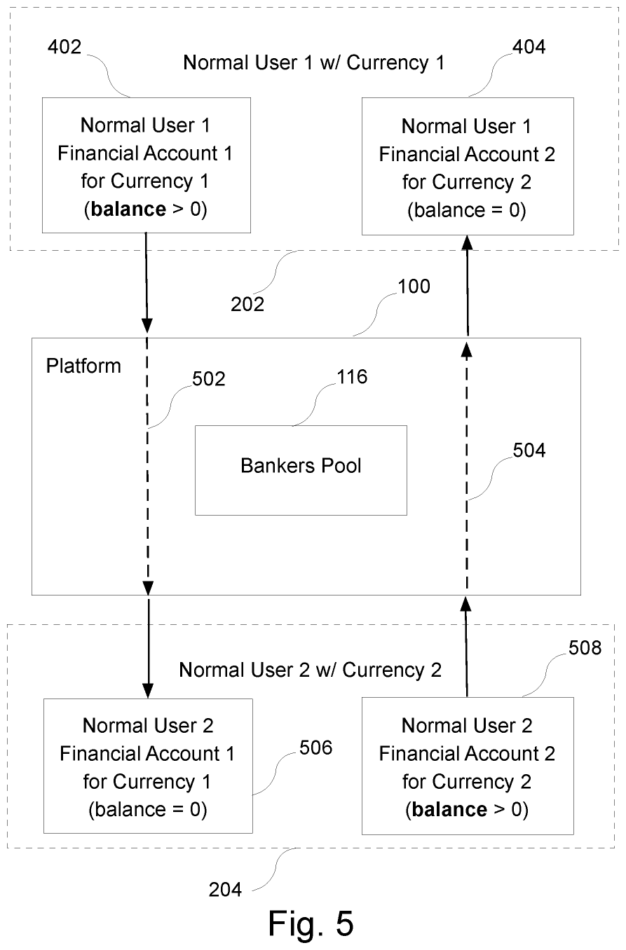

FIG. 5 embodies a method of two normal users transferring currency between themselves, each using two different financial accounts, with both transactions going through the platform (100) but without using the bankers' pool (116). Normal User 1 (202) has Financial Account 1 with Currency 1 (402), and Financial Account 2 with Currency 2 (404). Financial Account 1's (402) balance is greater than 0, while Financial Account 2's (404) balance is 0. Normal User 2 (204), also has 2 financial accounts (Financial Account 1 for Currency 1 (506) and Financial Account 2 for Currency 2 (508)). Financial Account 1's (506) balance is 0 while financial Account 2's (508) balance is greater than 0.

A trade is made between Normal User 1 (202) and Normal User 2 (204), where Normal User 1 wants to exchange Currency 1 for Currency 2 and Normal User 2 (204) wants to do the opposite. Once the trade has been agreed upon, the money is transferred (502) through the platform (100). Normal User 2 (204), then receives the Currency 1 from Normal User 1 (202) in their account for Currency 1 (506). Normal User 1 (202) receives the Currency 2 from Normal User 2 (204) in their account for Currency 2 (404). This completes the overarching transaction.

This figure shows how two users can complete a transaction of currency using two different financial accounts each. In a real-world example, a transaction would play out as such: Normal User 1 (202) has set up two platform financial accounts which could have received currency from two real financial accounts (402, 404), such as those with a bank, which have a balance of some amount of Currency 1 and a balance of 0 of Currency 2 respectively. Normal User 2 (204) has also set up 2 financial accounts (506, 508), which contain a balance of 0 for Currency 1 and a non-zero balance for Currency 2 respectively. The two users can then use their accounts to perform an exchange of currency through the forex platform (100), without requiring the use of the bankers' pool (116). The exchange would follow the same general pattern as the single user, multiple account exchange detailed in FIG. 4, though now Normal User 1 (202) exchanges the Currency 1 in their account 1 (402) via the platform (502) to user 2's reserved account for Currency 1 (506), and User 2 sends their balance of Currency 2 (508) through the platform (504) to User 1's reserved account for Currency 2 (404), which completes the transaction.

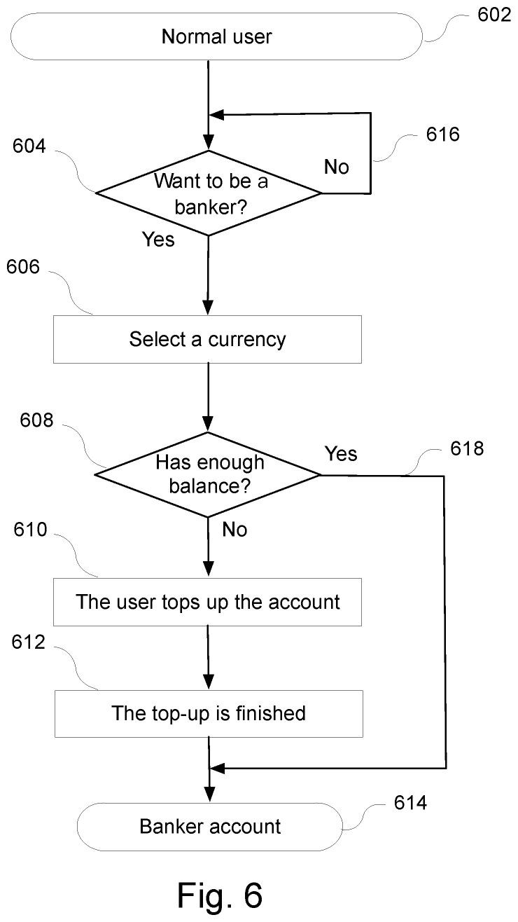

FIG. 6 is a flow diagram of the process a normal user (602) can go through to become a ubering user. First, we start with a normal user (602). Then the user is asked if they want to be a banker (604)—if they answer no (616), the user can still answer yes at a later date and complete this process if they so choose. If the normal user (602) answers yes, they move on to the next step, which is selecting a currency (606), where they choose a currency to specialize in trading. For example, a user owns Canadian dollars and selects to trade for US dollars, GBP, EURO, or any other currency the platform supports, or any combination of the currencies at the same time.

After this, the user has their account checked (608) to see if it has a high enough balance for the duties of a banker user. If the user meets the requirements (618), they move straight to the conversion to a banker account (614). If they do not meet the requirements (608), they move to the next step, requiring the user to fill their platform financial account (610) until they have sufficient currency for trading. This can be done by depositing money from an outside financial account, which includes but is not limited to, a bank, PayPal account, cash deposit, or a cheque. Once this top-up task is completed (612), that is, enough money has been deposited into their platform financial account, the user's account is converted to a banker's account (614).

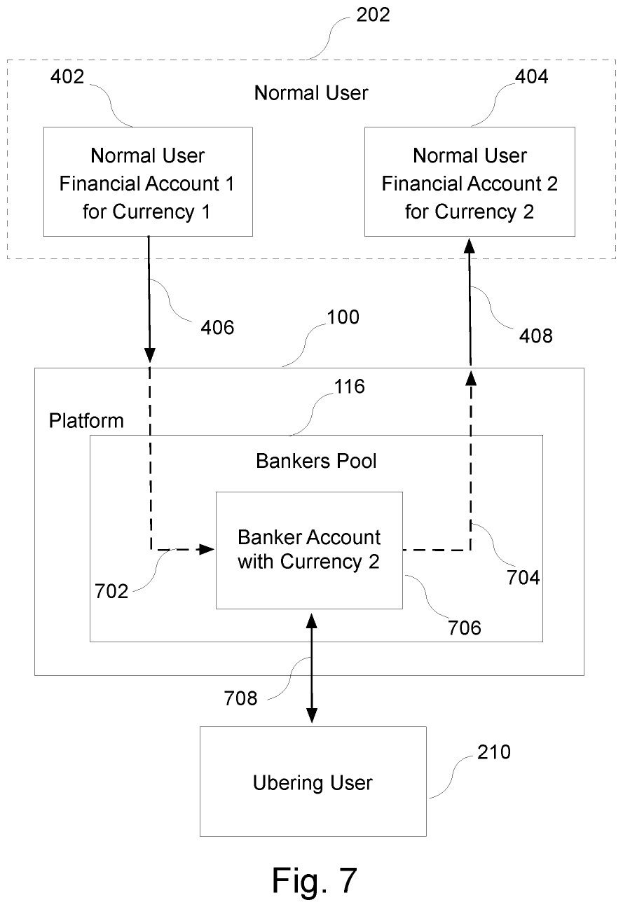

FIG. 7 displays a scenario where a user exchanges currency on the platform with an ubering banker user. Normal User (202) has a financial account with Currency 1 (402) from which Currency 1 is transferred to the platform (100) through some device or method (406). Then Normal User (202) can start a trade for Currency 1 to Currency 2. If there are no other normal users that can complete the requested trade, the transaction is displayed to the bankers' pool (116) via some method (702).

An ubering user (210) has a banker account on the platform (708) with the desired Currency 2 (706) and responds to the pending request. Then, the original currency is sent to the banker account (706), and Currency 2 is transferred out of the platform (704) which then transfers (408) the normal user's second financial account for Currency 2 (404). Through the method described here, a normal user can convert currency between two of their own accounts, making use of the platform's banker account system even when there are no regular users available with the appropriate trades.

For example, a normal user (202) has two financial accounts (402, 404) which are for Currency and Currency 2. The normal user in question can then make an exchange request (406) to the platform (100). There are no regular users to complete the trade with, so the request is then shown to the bankers' pool (116) and responded to (708) by an ubering user (210) with a banker account containing Currency 2 (706). The correct amount of Currency 1 is transferred from the normal user's financial account (402) through the platform, that is, into a platform financial account (406) and then transferred from there into the bankers' account (706). The equivalent amount of Currency 2 is transferred (704) out of the banker's platform financial account (706), out of the platform (100) itself, and into the normal user's financial account for Currency 2 (404). This completes the overall transaction.

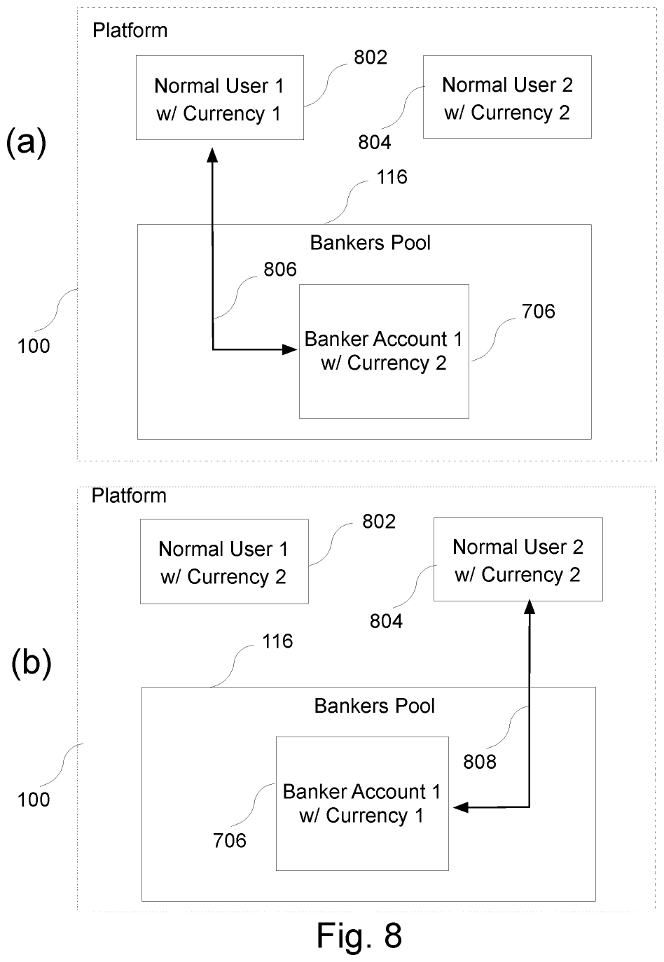

FIG. 8 demonstrates two steps—Sub-Fig (a) and Sub-Fig (b), a method through which a banker account can ‘flip’ currency after transactions are completed. This essentially means that a banker who starts off with Currency 1, can exchange it for Currency 2, and then exchanges that Currency 2 back to Currency 1. He or she repeats this process repeatedly, thereby ‘flipping’ his or her currency.

This process occurs within the application's platform (100) and involves three users, two normal users with currencies 1 and 2 (802 and 804 respectively), and a banker user with a banker account (706). Normal User 1 is trying to convert their Currency 1 into Currency 2, while Normal User 2 is trying to convert their Currency 2 into Currency 1. The banker has started off with a stock of Currency 2 in their banker account (706). In Sub-Fig (a), a trade happens between User 1 and the banker. The Normal User 1 transfers Currency 1 (806) to a banker account (706) in the bankers' pool (116) in exchange for Currency 2. At this point in the process, Normal User 1 has completed their requested transaction, and the banker user has exchanged his or her stock of Currency 2 for the equivalent amount of Currency 1.

Then, in Sub-Fig (b), the banker user who now has Currency 1 wants to exchange it back to Currency 2, what they originally had. A trade is made between the banker and another normal user that wants to exchange Currency 2 for Currency 1. The banker transfers Currency 1 (808) to normal user 2 for their stock of Currency 2. Now the banker user has completed 2 transactions, which comes with various extra benefits to incentivize users to become bankers and at the same time reclaimed their original balance of the currency, which allows them to continue trading Currency 2 as they were before. For example, this method could be used to allow ubering users to quickly turn a profit from this platform, using this technique to ‘flip’ currencies at different exchange rates and to collect rewards from the platform for facilitating transactions.

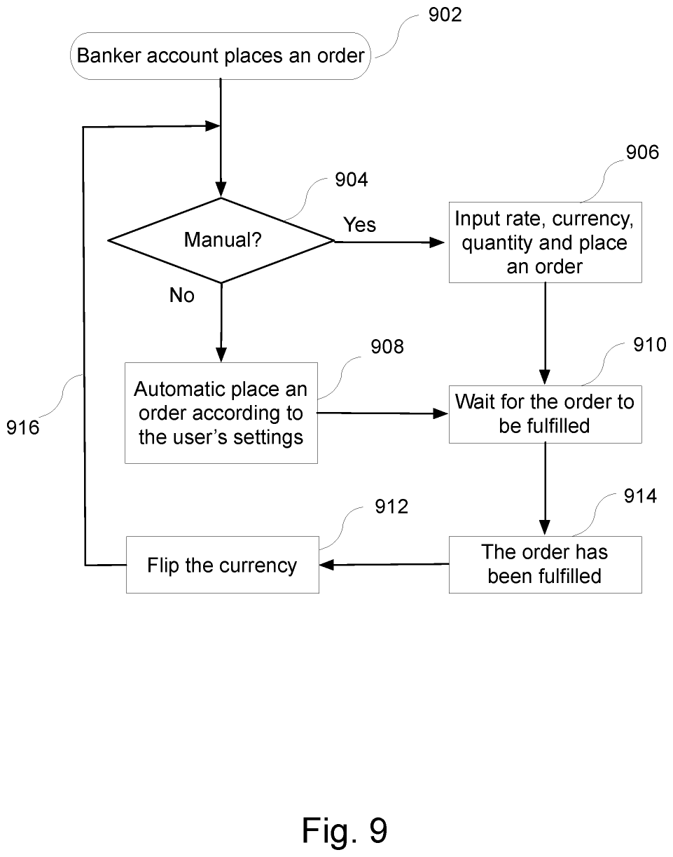

FIG. 9 manifests an algorithm for auto-matching orders with bankers and calculating rates for transferring currency. At the beginning of the algorithm, a banker account places an order (902) on the P2P forex platform. After this occurs, the application asks if the transaction should be manual or not (904). If yes, then the user inputs exchange rate and currency quantity and places an order (906), which then moves into a queue to wait to be fulfilled (910). If no, the order is automatically placed according to the user's preset settings (908) and moves into the queue to be fulfilled. After either a manual or automatic order is fulfilled (914), the banker user can ‘flip’ the currency (912) as outlined in FIG. 8, then return to the first step in the process (916) and repeat as many times as desired. In automatic ordering according to the user's settings, the exchange rate will automatically be calculated according to weighting. This calculation method is as such: Assume that the exchange amount that can be traded is A, and the amount of each transaction is A (1), A (2), . . . to A(n) (n being the arbitrary maximum number of transactions). The exchange rates for each transaction are then R (1), R (2), . . . to R (n), respectively, then the average exchange rate is calculation as R=(A(1)*R(1)+A(2)*R(2)+A(3)*R(3) . . . +A(n)*R(n))/A.

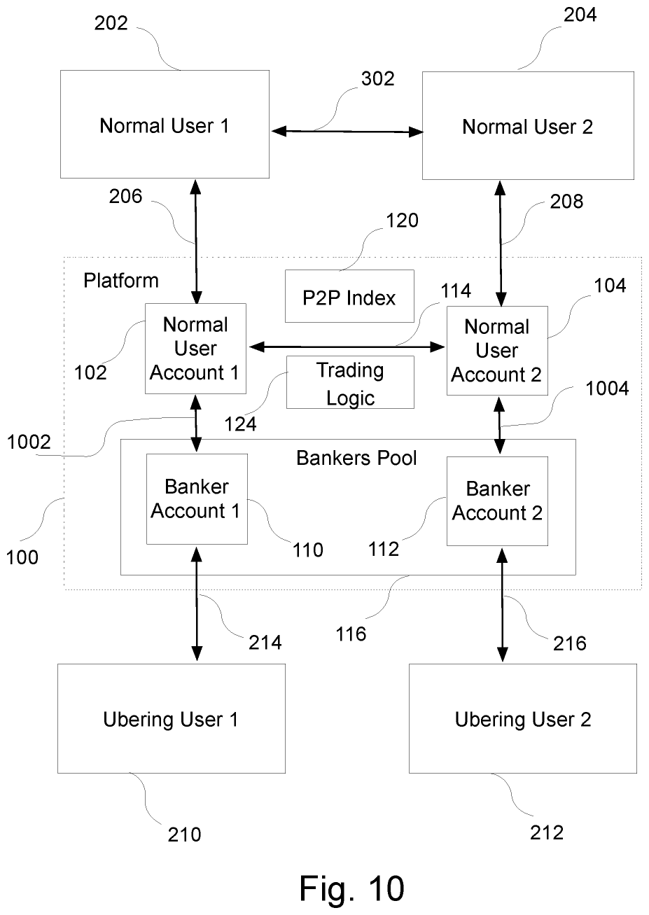

FIG. 10 is a complete manifestation of the methods and structure of the forex platform as defined in the figures above. This figure displays two normal users (202 and 204) who can connect with each other without making use of the platform (302) or via the platform (100) though some methods (206, 208). The platform itself includes the P2P index (120), containing a list of all users capable of using the peer-to-peer capabilities of the platform. The platform (100) also contains Trading Logic (124) that allows trades to occur, as well as user accounts (in this case normal users 1 and 2, which are 102 and 104 respectively) and the banker's pool, which houses the ubering users' banker accounts (banker accounts 1 and 2 at 110 and 112 respectively). The ubering users themselves (210, 212) connect to the platform (100) through the same methods (214, 216) as their normal user counterparts, which allows for two-way communication between the user and the platform, as well as direct communication with other users. Within the platform (100), the normal user accounts have a two-way connection with the banker accounts in the banker pool (116) via the platform (1002, 1004). This embodiment shows an overview of the methods and structure of the forex platform and as such examples of this embodiment can take the form of all figures listed above: i.e. a normal user with one or more accounts could exchange currency with one or more other normal users or ubering users, using one or more financial accounts each to house various currencies for exchange.

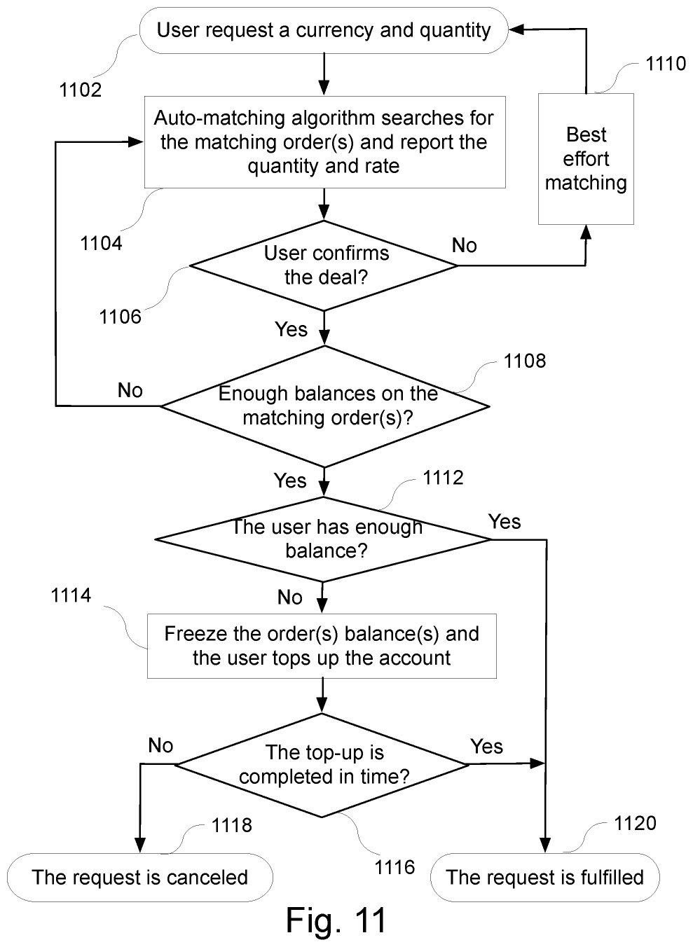

FIG. 11 is an ideal embodiment of a general algorithm for completing a transaction of currency using this forex platform. At the beginning of this process, a normal user requests a currency and a quantity of said currency (1102). After this, an auto-matching algorithm searches for matching orders from other users or banker users and reports the quantity and rate to the exchange (1104). After this process, the user is given a choice to confirm the deal (1106) assuming good matches are found. If the user answers no (1110), they are taken back to the original step (1102) of requesting a currency and quantity. If the user confirms the deal, the system then checks if the accounts have enough balance on the matched order(s) (1108). If no, then the user is sent back to the auto-matched list of transactions they encountered originally (1104). If yes, then the user's account is checked to see if it has enough balance (1112). If it does, then the platform immediately fulfills the request (1120). If the account does not contain the required balance, then the platform freezes the order, giving the user a chance to top-up their account without canceling the entire transaction (1114), but with a time limit, as the platform cannot freeze transactions indefinitely. The platform then checks if the top-up is completed in time (1116). If it is not, the request is canceled with the transaction (1118), and if it is, then the request is fulfilled (1120) and the user is free to request more currencies and quantities. Each deal requires the user's confirmation on the price and quantity, etc., so, users have full control of the transactions.

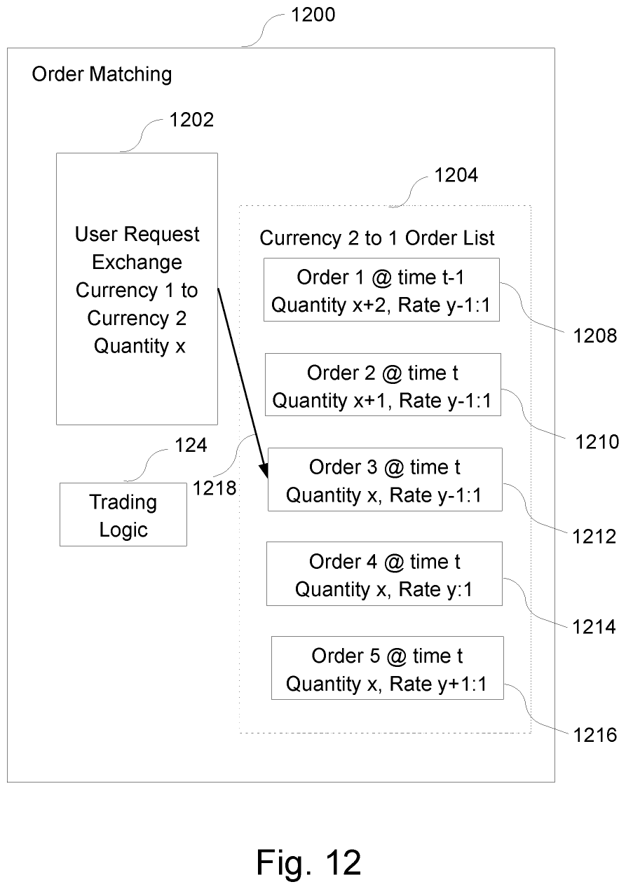

FIG. 12 embodies a simple algorithm to sort trade orders. The order published by the user pool user (banker) is synchronized to the in-memory database to create a list of currency pairs, which is sorted and used by the trading algorithms. The sorting priorities are in the order of the following four characteristics: 1. Currency pairs; 2. Exchange rates, with lower rates being sorted first; 3. Timestamps, with earlier requests being sorted first; 4. Quantity, with larger trades being sorted first.

In the in-memory database, the transaction currency pairs are sorted according to the exchange, and a sorted order list is created for each category. For example, all orders for the US dollar for Canadian dollars enter the same list, L1, while orders for Canadian dollars for the US dollar enter another list, L2. The ordering rules apply to the orders in the order list. First, orders with the best exchange rate are ranked highest, from the perspective of the order taker. That is, for the order-placing user, the lowest exchange rate ranking is the first priority. Secondly, if the exchange rates of two orders are the same, the earlier the pending orders are, the higher the priority. For example, the order for the US dollar against the Canadian dollar has three orders, A, B, and C. The exchange rates are 1.3, 1.4, and 1.4, respectively, and the pending orders are 9:40, 9:30, and 9:29. The demand for users who receive orders is to exchange Canadian dollars for US dollars. For single users, 1.3 is a better exchange rate than 1.4. The exchange rate of order A is 1.3, so A should be ranked first, leaving the exchange rate of orders B and C. According to the order of pending orders, C's pending order time is earlier than B's, so C should be ranked in front of B, and the final order is A, C, B.

After each new order is generated and written to the database, an identical record will be inserted into the in-memory database. The insertion location is searched for as follows: First, find the list of the same exchange currency pair for this order, according to the sorting rule described above. Starting from the first order C1, if the exchange rate is less than C1, it is ranked before C1. If the exchange rate is greater than or equal to C1, then it is compared to C2 after C1, where the comparison rule with C2 is consistent with that of C1, and so on until inserted into the correct sort position.

If there is a change in the order status, the database is updated first, then the sorted list in the in-memory database. The specific circumstances include: (a) There is a change in the remaining amount of the order due to the user's order transaction. After updating the database order record, it also needs to sort the list in the in-memory database to find the same order and update the remaining amount of the order. (b) The order is canceled and the same order in the sorted list in the in-memory database is also deleted. (c) The order has been completed, there is no balance, and the same order in the sorted list in the in-memory database is also deleted.

Automatic matching of normal users. The user inputs the currency to be exchanged, the target currency, and the amount to be redeemed. After receiving the information, the server searches the pre-ordered pending order list and matches the user's needs according to the matching algorithm. The process is described as follows:

Step 1: After the transaction demand (transaction currency pair, amount) of the user's transaction is submitted to the server, the program will scan the list of the same currency pair in order. If the order amount of the first order is not enough for the user's demand, then it will continue to add the second order amount and so on, until all the user's demand for the exchange amount is reached. Another possibility is that all the remaining amounts of the published orders plus the amount of the foreign exchange are insufficient for the user's demand, in which case the remaining amount of all orders will be partially sold as the total amount of the transaction. After the scan is over, it is necessary to record which orders will be fulfilled with this user during this scan, as well as the transaction amount for each order. The average exchange rate of the deal is calculated by weighting. The calculation method is as follows: Assume that the exchange amount of the order that can be traded after the scan is M, and the exchange amount of each contract is M1, M2 . . . , and the exchange rate is R1, R2 . . . respectively, then the average exchange rate is R.=(M1*R1+M2*R2+ . . . )/M. This generates a unique calculation number.

The calculation result is divided into two parts: The first part (Result Part 1) includes the average exchange rate, the transaction amount, the amount of the original currency that can be traded, the amount of the target currency to be exchanged, and the calculation number. The second part (Result Part 2) includes the order number of each order and the amount of the transaction. The above process is called scanning computation before transaction. The first part (Result Part 1) is saved and returned to the user client. The second part (Result Part 2) is stored only on the server-side. The following examples illustrate:

Example one: Suppose User A needs to exchange 5000 USD for Canadian dollars. After inputting the exchange demand, it is sent to the server. The server program will scan the list of pending orders for Canadian dollars. The pending order list is an ordered order (orders are orders placed by the user pool user banker). Assume that the order numbers of the top three orders in the list are C1, C2, C3, and the remaining exchange amounts are 4000 Canadian dollars, 2000 Canadian dollars, and 1000 Canadian dollars, and the pending order exchange rates (CAD/USD) are 0.7407, 0.7575, 0.7692, respectively. The user exchanges $2962.8 USD with C1, $1515 USD with C2, $522.2 USD with C3, and gets $4000, $2000, and $678.89 Canadian dollars, respectively. The average exchange rate is (4000*0.7407+2000*0.7575+678.89*0.7692)/6678.89=5000/6678.89=0.7486. For the user side, the exchange rate of the US dollar for the Canadian dollar is expected to be 1/0.7486=1.3358

After the calculation is completed, the calculation result is: order numbers C1, C2, and C3 and the amounts of the respective transactions 4000, 2000, and 678.89. The program then generates a unique calculation result number R1 and saves it with the aforementioned calculation results in the database. At this time, it is not a real transaction but a pre-calculation. Next, the calculation result is returned to User A. The content of the result includes: the calculation number R1, the transaction amount of 5000 US dollars, the exchange amount of 6678.89 Canadian dollars, and the average exchange rate of 1.3358.

Example two: Suppose User A needs to exchange 5000 USD for Canadian dollars. After inputting the exchange demand, it is sent to the server. The server program will scan the list of pending orders for Canadian dollars. The pending order list is an ordered order (orders are orders placed by the user pool user banker). Assume that the order list has only 2 orders; the order numbers are C1 and C2 and the remaining amounts of the order are 2000 Canadian dollars and 1000 Canadian dollars, respectively. The exchange rates of the pending orders are 0.7407 and 0.7575 respectively. At this point, the C1 order will be fulfilled with 2000*0.7407=1481.7 USD, and the C2 order will be sold for 1000*0.7575=757.5 USD. The two orders total $2238.9. The average exchange rate is (2000*0.7407+1000*0.7575)/3000=0.7463 CAD/USD. The program then generates a unique calculation result number R2 and saves it with the aforementioned calculation results to the database. At this time, it is not a real transaction but a pre-calculation. Then, the calculation result is returned to User A. The content of the result includes the calculation number R2, the transaction amount of 2238.9 US dollars, the conversion to 3000 Canadian dollars, and the average exchange rate 1.3399 (1/0.7463).

Step 2: The user receives the calculated result of the returned pre-sale scan and checks the transaction amount that can be redeemed (how much of the original currency amount is converted into the target currency amount) as well as the calculated average exchange rate. If the user confirms that the transaction is based on this amount and the exchange rate, he or she sends the calculation number to the server and proceeds to the next step. If the user does not confirm the transaction in this way, the transaction is cancelled.

Step 3: The server receives the information of the transaction determined by the user and takes the calculation number from the information, so as to find out the calculation result of the previous pre-scan according to the number. According to each order number in the calculation result, the second part (Result Part 2) of the original calculation result is searched for in the database and checked into the database to check whether each order number order in the original result is valid and the pre-calculated balance is sufficient. If even one order does not satisfy the balance calculated by the original or the status has been canceled, the transaction fails, returning to the above Step 1 for re-scanning a match.

Step 4: If the above Step 3 can successfully match the order, then the payment clearing step is entered. First, it is necessary to check whether the user's account balance is sufficient to achieve the amount of the original currency that can be sold in according to the above calculation result. If the balance is sufficient, the deduction will be made directly. If the balance is insufficient, then the calculated transaction amount for all orders will enter the frozen amount of the order. This part of the frozen amount cannot be scanned by or traded with other users. The frozen duration is configured by the system. At this point, the user can select the payment channel to make the payment. If he or she does not pay by the timeout, the frozen amount of all orders for this transaction will be returned to the balance of the corresponding order, and the transaction can be re-matched by the user.

In FIG. 12, the order matching algorithm is shown as the main object (1200). This also includes the trading logic (124). The user requests to exchange currency (in this case, Currency 1 to Currency 2) in quantity x (1202) is given to the algorithm. Based on the trading logic, the order is then to match a stack of existing pending orders (1204). In this embodiment, five potential pending orders of the same currency exchanging pair are shown (1208, 1210, 1212, 1214, 1216), each at a particular time, quantity, and rate, and ordered according to the sorting rules above.

For the example shown, the system scans through the orders according to the ranking: Order 1 (1208) happened at time t−1, has a quantity of x+2, and a rate from Currency 1 to Currency 2 of y−1:1; Order 2 (1210) occurred at t, has a quantity of x+1, and a rate of y−1:1; Order 3 (1212) also occurred at t, has a quantity of x, and a rate of y−1:1; Order 4 (1214) also occurred at t, has a quantity of x, and a rate of y:1; and Order 5 (1216) also occurred at t, has a quantity of x, and a rate of y+1:1. The sorting would be: from Order 1 to 5 with Order 1 being the first due to the lower exchange rate, then since Order 1 and 2 are equivalent in the exchange rate, Order 1 precedes Order 2 because it occurred earlier.

The trading algorithm first looks at Order 1 (1208), and the price and timestamp are alright. However, the quantity x+2 is greater than the requested x. It continues to scan Order 2 (1210) and Order 3 (1212) until it finds Order 3 (1212) to be the best match (1218) with the same lowest price and early timestamp but exact currency quantity. Exact match in quantity takes higher priority for trading efficiency. If an exact quantity match cannot be found, then the partial matching will start from the first pending order in the order list (1204) to the last, and take as many orders as needed until the user requested quantity x is fulfilled.

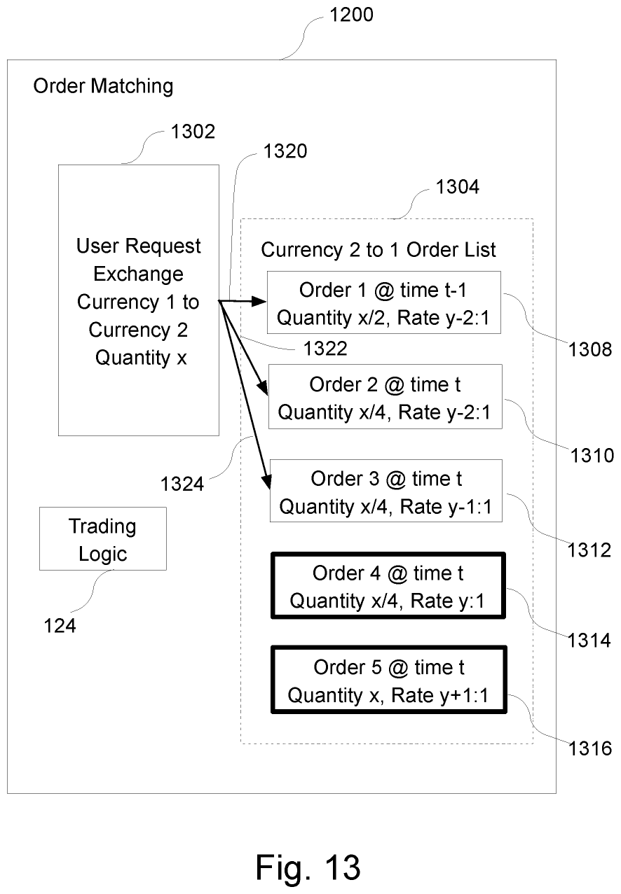

FIG. 13 is the more complex embodiment of an algorithm for order matching. The exchange rate, in this case, is a weighted average of the matched pending order prices. The exchange amount M, for each contract, would be M1, M2, M3, and so on. The exchange rate can similarly be denoted as R1, R2, R3, and so on for each transaction. The average exchange rate can thus be denoted by the formula: R=((M1*R1)+(M2*R2)+ . . . (Mn+Rn))/M. In this figure, the order matching algorithm (1200) encompasses all other components and contains the trading logic (124) required for the system to work. A user then puts in a request to exchange Currency 1 to Currency 2 (1302) in quantity x and rate y:1.

The system has a Currency 2 to Currency 1 pending order list (1304). Order 1 (1308) happened at time t−1, has a quantity of x/2, and a rate from Currency 1 to Currency 2 of y−2:1; Order 2 (1310) occurred at t, has a quantity of x/4, and a rate of y−2:1; Order 3 (1312) also occurred at t, has a quantity of x/4, and a rate of y−1:1; Order 4 (1314) also occurred at t, has a quantity of x/4, and a rate of y:1; and Order 5 (1316) also occurred at t, has a quantity of x, and a rate of y+1:1. The sorting order would be from Orders 1 to 5 with Order 1 as the first.

The system searches for and matches the first three orders because Order 1 only fulfills half of the required quantity, Order 2 fulfills one-quarter of it, and Order 3 happens to fulfill the rest. The request can then split this exchange (1302) into 3 separate orders (1320, 1322, 1324), which can be fulfilled by other separate users, allowing exchange requests of large quantities to be fulfilled properly despite their large size. The average exchange rate will be calculated as (x/2*(y−2)+x/4*(y−2)+x/4*(y−1))/x=(y−1.75):1.

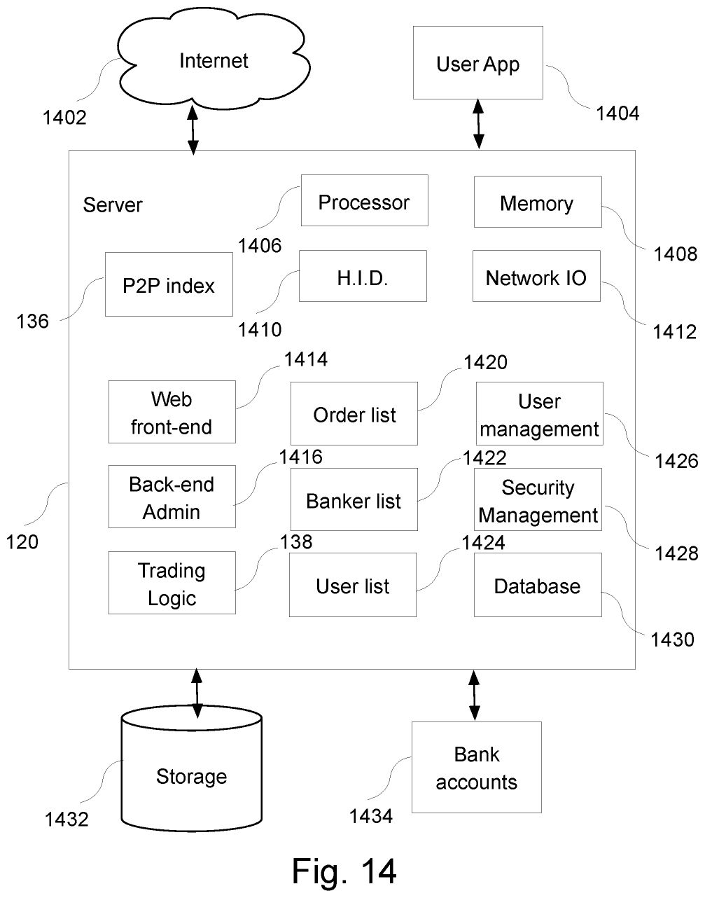

FIG. 14 is an embodiment of the system design which facilitates implementing all previously described methods' embodiments. The system may include any combination of hardware, software, and connections with external components. The system may be implemented as a web application or web service with or without a mobile application downloadable from the App Store, Play Store, or other application stores. The mobile application software can be installed and run on smartphones, tablets, and other smart mobile devices.

The hardware involved is mainly a server (120) which includes H.I.D (Human Interface Devices) (1410), a CPU (Central Processing Unit) (1406), RAM (Random Access Memory) (1408), Network 10 (Input/Output) devices (1412), and storage (1432) connected to the server to house the application platform and operating system. The software housed by the server includes the P2P index of users (136), the web front-end (1414), the list of orders (1420), user management software (1426), the banker user list (1422), the regular user list (1424), back-end administration tools (1416), security management software (1428), the trading logic (138), and a general database (1430); wherein the trading logic (138), the banker user list (1422), the regular user list (1424), the list of orders (1420), and database (1430) together implement the aforementioned trading algorithms and processes. The trading logic (138), user management (1426), security management (1428), and back-end administration (1416) are mainly run on the processor (1406) and memory (1408).

The server is also connected to the external bank and/or other financial accounts (1434), which allow users to store money outside the service. The server also connects to the internet (1402), allowing users to access their account via the web front-end (1414) interface. The platform server also connects to the external user desktop and/or mobile applications (1404) which serve as a front-end for the majority of users of the platform.

1. A method for fulfilling a first user's request to exchange a first currency to a second currency through an online platform, comprising:
providing a server that serves the platform;
providing a first platform function for the first user to broadcast the request via the platform to a plurality of other users;
wherein the other users include at least one ubering user and may include active regular and/or inactive regular users;
wherein the first user is one of the active regular users and the ubering users are always active and ready to exchange currency from the second currency via the platform to the first currency and/or vice versa;
providing a second platform function to match at least a second user to fulfill the first user's request at an exchange rate via the platform;
wherein the second user may be an active regular or ubering user;
providing a third platform function to complete the currency exchange transaction between the first and second users via the platform;
wherein the platform rewards the second user for completing the currency exchange transaction if the second user is a ubering user.

2. The method of claim 1, wherein the ubering users include pre-contracted businesses and/or individuals with the motivation to make profits by providing currency exchange transactions for the platform.

3. The method of claim 1, wherein any regular user can file an application to become a ubering user provided the balance of a currency in the user's account meets the platform requirement; any ubering user can file another application to become a regular user as well.

4. The method of claim 1, wherein each user has at least one account with the platform and a balance of a platform supported currency; wherein the platform account may connect with at least one external financial account.

5. The method of claim 1, wherein the platform is a decentralized peer-to-peer network.

6. The method of claim 1, wherein the first user's request also contains a desired currency exchange rate and each of the other active regular and ubering users may also post or respond to one currency exchange request with another desired currency exchange rate.

7. The method of claim 6, wherein the ubering user may initially post or respond to a request to exchange a first amount of the second currency for a second amount of the first currency; after the successful currency exchange, the ubering user can flip the request or response to exchange the second amount of the first currency for the first amount of the second currency.

8. The method of claim 6, wherein the first user's request may be partially fulfilled by the second user alone or additionally by a third user; wherein the first user's request may be completely fulfilled by multiple other users; wherein the request or response of one of the other users may also be partially fulfilled during the transaction; wherein the request or response of one of the other users may involve a third currency.

9. The method of claim 6, wherein the final currency exchange rate is determined with an algorithm via the platform housed in the server and the final currency exchange rate requires a confirmation from the first user.

10. The method of claim 9, wherein the algorithm may look for the second user whose currency exchange rate is the most favorable to the first user or the second user whose desired currency exchange rate is the closest to the first user's desired currency exchange rate.

11. The method of claim 9, wherein the algorithm may respect the order and timestamps when the users post their currency exchange requests or respond to the first user's request and/or minimize the number of total users who fulfill the first user's request.

12. The method of claim 9, wherein the algorithm may preferably select a second user who is an active regular user; if an active regular user is unavailable, a matching ubering user will be selected to fulfill the first user's request.

13. The method of claim 4, wherein the currency exchange transaction may occur between all the different accounts.

14. The method of claim 1, wherein the first and second users are in different countries.

15. A system implements a platform for fulfilling a first user's request to exchange a first currency to a second currency, comprising:
a server that serves the platform;
a first platform function for the first user to broadcast the request via the platform to a plurality of other users;
wherein the other users include at least one ubering user and may include active regular and inactive regular users;
wherein the first user is one of the active regular and the ubering users are always active and ready to exchange currency from the second currency via the platform to the first currency and/or vice versa;
a second platform function to match at least a second user to fulfill the first user's request via the platform;
wherein the second user may be an active regular or ubering user;
a third platform function to complete the currency exchange transaction between the first and second users via the platform;
wherein the platform rewards the second user for completing the currency exchange transaction if the second user is a ubering user.

16. The system of claim 15, wherein the platform may include any combination of webservers, smart mobile devices, mobile software applications, and/or cloud storages; each system components may be connected through the wired or wireless Internet connection, cellular network, or other technologies; wherein the platform can be a decentralized peer-to-peer network.

17. The system of claim 15, wherein each user has at least one account with the platform and a balance of a platform supported currency; wherein the platform account may connect with at least one external financial account; wherein the currency exchange transaction may occur between all the different accounts; wherein the first user's request may be partially fulfilled by the second user alone or additionally by a third user; wherein the first user's request may be completely fulfilled by multiple other users; wherein the request or response of one of the other users may also be partially fulfilled or involve a third currency during the transaction.

18. The system of claim 15, wherein any regular user can elect to file an application to become a ubering user provided the balance of a currency in the user's account meets the platform requirement; any ubering user can elect to file an application to become a regular user as well; wherein the first and second users may be in different countries; wherein the first and second currencies may be the same currency.

19. The system of claim 15, wherein the ubering user may initially post or respond to a request to exchange a first amount of the second currency for a second amount of the first currency; after the successful currency exchange, the ubering user may flip the request or response to exchange the second amount of the first currency for the first amount of the second currency.

20. The system of claim 15, wherein the final currency exchange rate is determined with an algorithm and the final currency exchange rate requires a confirmation from the first user; wherein the algorithm may look for the second user whose currency exchange rate is the most favorable to the first user; or the second user whose desired currency exchange rate is the closest to the first user's desired currency exchange rate; wherein the algorithm may also minimize the number of total users who fulfill the first user's request and/or respect the order and timestamps when the users posts their currency exchange requests or responds to the first user's request; wherein the algorithm may preferably select a second user who is an active regular user; if an active regular user is unavailable, a matching ubering user will be selected to fulfill the first user's request.
